(19) United States
(12) Patent Application Publication
(10) Pub. No.: US 2016/0115734 A1
(43) Pub. Date: Apr. 28, 2016

(54) WINDOW SHADE LINKING DEVICE

(71) Applicant: Carl Seaberg, Indianapolis, IN (US)

(72) Inventor: Carl Seaberg, Indianapolis, IN (US)

(21) Appl. No.: 14/526,026

(22) Filed: Oct. 28, 2014

(51) Int. Cl. E06B 9/68; E06B 9/62; E06B 9/60; E06B 9/40; E06B 9/44

(52) U.S. Cl. CPC E06B 9/68; E06B 9/40; E06B 9/44; E06B 9/60; E06B 9/62

(57) ABSTRACT

A system for mounting an adjustable height window covering to a window frame that includes a line orienting members and a line as part of a tension pathway that contacts at least one of the line orienting members. The tension pathway extends along both vertical sides of the window frame and crosses the window frame in front of the window.

### BACKGROUND OF THE INVENTION

There are a variety of window treatments that may be used to control the amount of light that is allowed into an interior space. At times, it may be desired to allow light into an interior space through one part of a window while blocking the light from another part of the window. Many window coverings are mounted at the top of the window and limited to blocking light from the top portion of the window if the light on the bottom portion of the window is blocked.

In some situations, however, a user may wish to allow light from the top portion of the window to pass while blocking the light coming from the lower portion of the window. This is hard to achieve with a window covering mounted at a permanent height. Therefore, it is desirable to find an improvement that allows greater control for the amount and positioning of the light that is allowed to pass through a window into an interior space. Various optional features herein, alone or in combination, may address one or more of these considerations.

### SUMMARY OF THE INVENTION

In some embodiments, a system for mounting a window covering to a window frame is shown that includes a window frame, four line orienting members coupled to the window frame, two window covering engaging members, a line contacting each of the line orienting members, and a tension-applying member. The line orienting members are coupled to the vertical sides of the window frame so that each vertical side has an upper and lower line orienting member. One of the window covering engaging members is positioned between each of the upper and lower line orienting members. When the line extends between the vertical sides of the window frame, it extends from the upper line orienting member on one vertical side to the lower line orienting member on the other vertical side.

Another embodiment of a system for mounting a window covering to a window frame includes a window frame and a line orienting member and has a tension pathway that contacts the line orienting member. The tension pathway travels along both vertical sides of the window frame. When the tension pathway extends between the vertical sides of the window frame, it crosses an edge of the window frame at an angle that is preferably between 20 and 70 degrees. Movement of the tension pathway along one of the vertical sides of the window frame causes the tension pathway to move in the same direction on the other vertical side.

Another embodiment includes a kit for mounting a window covering to a window frame that includes a container that contains line orienting members, a line, a tension applying member, window covering engaging members, and instructions for mounting to a window frame.

Other embodiments of a system for mounting a window covering to a window frame include a tension pathway that includes a line and a tension spring. Also, other embodiments may include a counterweight coupled to a tension pathway and a window covering attached to the tension pathway so that movement of the tension pathway causes the height of the window covering to change in the opposite direction of the counterweight. Preferably the counterweight is concentric to the tension pathway, but alternatively it may be on a different path than shown in the drawings, such as it moves only vertically below one of the lower line orienting members.

Control of the position of the top of the window covering can be by the use of an electric motor that rotates a line orienting member, thereby moving the line to which the window covering is coupled, thereby moving the window covering. A suitable control of the electric motor can be supplied either directly as shown in FIG. 5, or through an equivalent wireless coupling well known in the art.

### BRIEF DESCRIPTION OF THE DRAWINGS

FIG. 1 is a front view of an embodiment of a system for mounting brackets and a window covering to a window frame.

FIG. 2 is a front view of brackets and a window covering apparatus attached to the system of FIG. 1.

FIG. 3 is a front view of the system and window covering apparatus of FIG. 2 with the window covering partially unrolled and covering the top half of a window.

FIG. 4 is a front view of the system and window covering apparatus of FIG. 2 with the window covering partially unrolled and covering the bottom half of a window.

FIG. 5 is a front view of the system of FIG. 2 with a counterweight and an electric motor and its associated control to simplify the positioning of the window shade.

FIG. 6 is a perspective view of a kit for mounting the system of FIG. 1 and associated brackets of FIG. 2 to a window frame.

### DESCRIPTION OF PREFERRED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

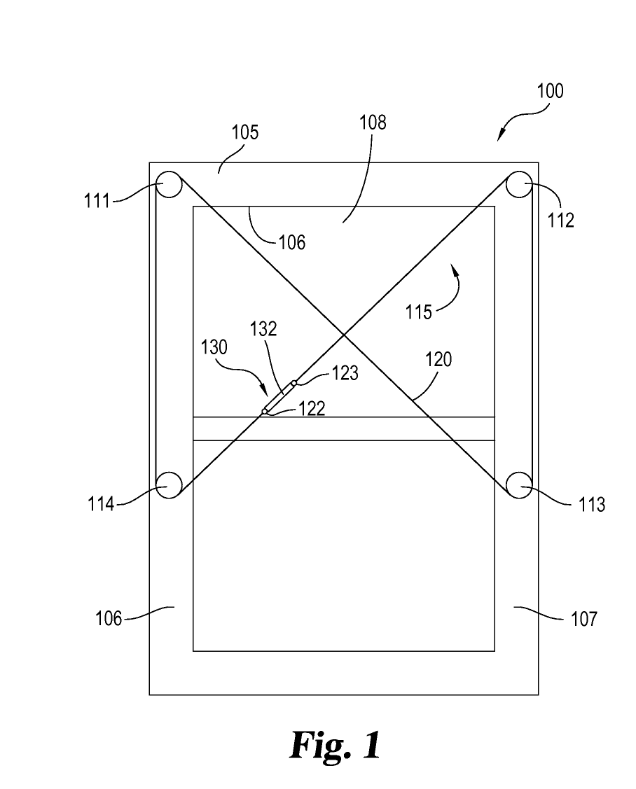

FIG. 1 illustrates an example of a system for mounting a window covering to a window frame generally designated 100. System 100 includes line orienting members 111, 112, 113, 114 attached to a window frame 105 that surrounds window 108. For the purposes of this application, a “window frame” refers to any trim or other material surrounding a window, in addition to the structural frame of the window. Line orienting members 111, 114 are attached on one of the vertical sides 106 of window frame 105 and line orienting members 112, 113 are attached on the opposite vertical side 107 of window frame 105.

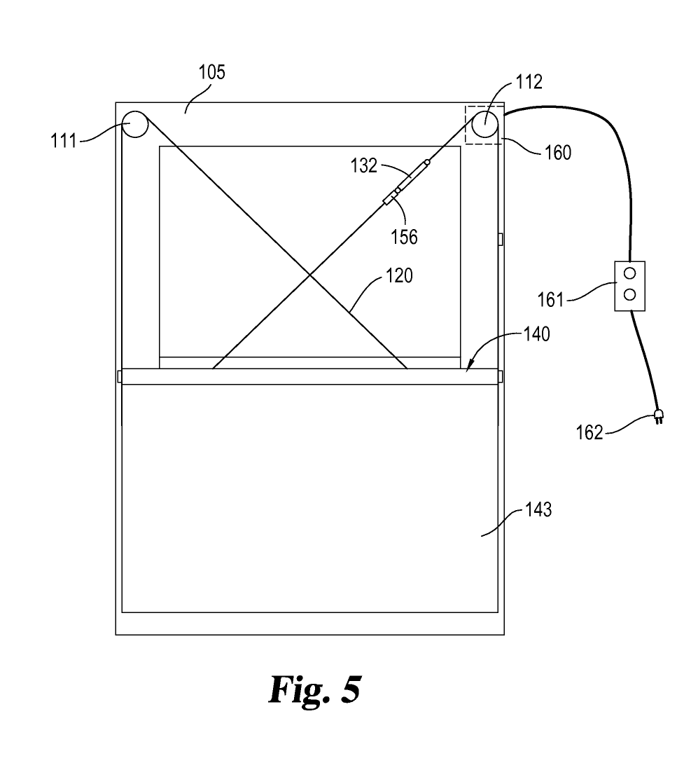

Line orienting members 111-114 may each be any apparatus that supports a line 120 and allows movement of the line about the line orienting member, such as by the member having a sufficiently low coefficient of friction to allow line 120 to slide along its surface or by allowing rotation of the member without the line sliding along its surface. For example, line orienting members 111-114 may be pulleys that rotate as line 120 is moved. Other examples include eyelets or stationary posts with low friction coatings, such as coatings containing polyfluorotetraethylene (PTFE). Such stationary posts may have grooves (not shown) to receive line 120. It is possible that in some embodiments, one or some of line orienting members 111-114 are rotatable while the other line orienting members 111-114 are stationary with low friction engagement of line 120. A high friction engagement of a line orientating member is particularly valuable if the member and therefor the line engaged with it is driven by an electric motor, as described later with regard to FIG. 5, or by a mechanical crank, not shown.

In some embodiments, line orienting members 111-114 may be mounted so that the diagonal pairs of line orienting members 111-114 are offset at different distances from window frame 105, so that they do not touch where they cross. For example, the path around line orienting members 111, 113 may be closer to the window frame than the path around line orienting members 112, 114. This allows portions line 120 or other objects attached to line 120 to freely cross past one another without touching where they cross.

Line orienting members 111-114 form the guides for a tension pathway 115. In the preferred embodiment shown in FIG. 1, tension pathway 115 extends among four line orienting members 111-114.

In some embodiments, tension pathway 115 may be formed from a single line 120 that contacts all of the line orienting members (see FIG. 1). Other embodiments may have multiple lines as segments attached at different points along tension pathway 115. Line 120 may be made of a variety of materials that allows movement on line orienting members 111-114. For example, line 120 may be made of metal, plastic, or cotton, with metal being preferred.

A tensioning applying member 130 applies tension to line 120 on tension pathway 115. In the embodiment shown in FIG. 1, a spring 132 is used for the tensioning applying member 130. Each end 122, 123 of line 120 is attached to a respective end of spring 132. The length of line 120 is sufficiently short to cause the ends 122, 123 of line 120 to stretch spring 132, placing tension on line 120.

Other embodiments not shown may use different ways to applying tension to line 120. For example, one or more of the line orienting members 111-114 may be inserted into a slot that contains a spring that is attached to window frame 105. Depending on its orientation, the spring may be either an extension or compression spring, or the design of the member itself may incorporate a spring-like action. In the embodiment of FIG. 1, line 120 wraps around line orienting members 111-114 and the extension spring 132 applies tension to line 120. In another embodiment, one of the lower line orienting members 113 or 114, or both may be attached to window frame 105 so it may move only vertically. A weight attached to, or a part of, the movable line orienting member pulls the line orienting member downward and thus applies tension to line 120.

FIGS. 1-5 show an embodiment where tension pathway 115 is formed by the ends 122 and 123 of line 120 attached to spring 132. In these embodiments, line 120 is preferably wrapped around the line orienting members so line 120 crosses itself in front of window 108, forming an “X” shape. Line 120 extends from its end 122 at spring 132 to line orienting member 114, then continues by wrapping partially around line orienting member 114 and then extending vertically to line orienting member 111, wrapping partially around it as well. Continuing on, line 120 then crosses window frame 105, extending from line orienting member 114 to line orienting member 112. As it crosses the edge 106 of window frame 105, line 120 preferably forms an angle with edge 106 that is between 20 degrees and 70 degrees. This angle is to be considered as viewed from the two dimensional vantage point of FIGS. 1-5, it being recognized that in three-dimensions, the line and edge may well be skew lines which would not touch to form any angle. From line orienting member 112, line 120 stretches downward to line orienting member 113. After wrapping around part of line orienting member 113, line 120 preferably again crosses window frame 105 and its end 123 attaches to spring 132. When line 120 is arranged as described, tension pathway 115 travels along both vertical sides 106, 107 of window frame 105. Movement of tension pathway 115 on one vertical side causes tension pathway 115 to move in the same direction as the other vertical side.

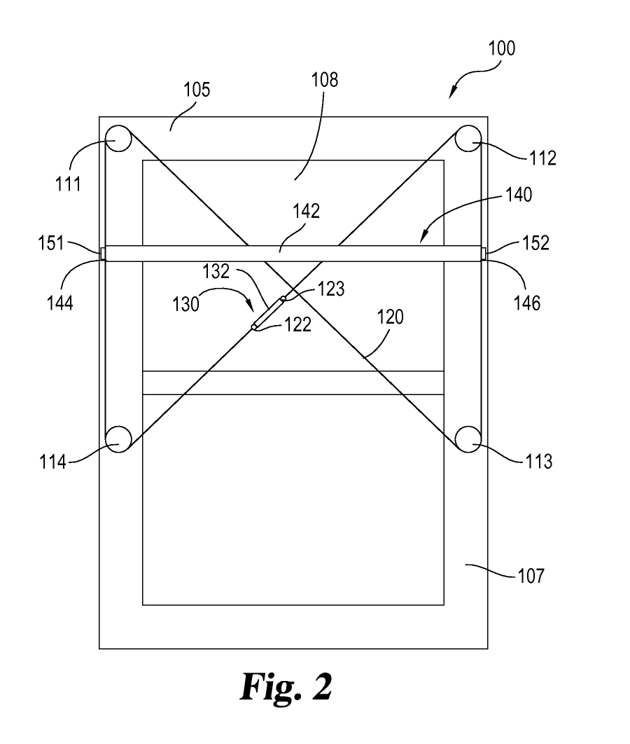

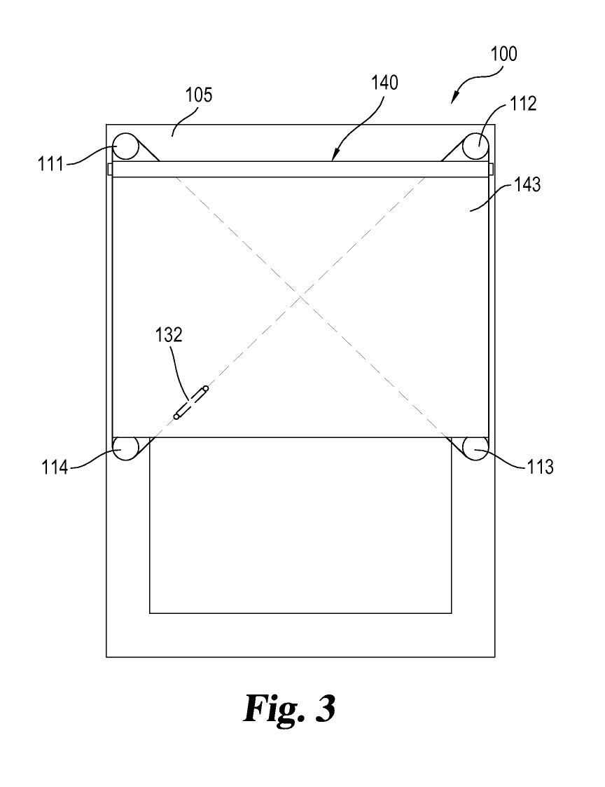

As illustrated in FIG. 2, a window covering apparatus 140 may be attached to line 120. Apparatus 140 includes a rod 142 with ends 144, 146. Ends 144, 146 attach to line 120 on opposite sides of the window frame. The ends 144, 146 of rod 142 are rotatably coupled to line 120 through brackets 151, 152 that serve as window covering engaging members. In some embodiments, a window covering 143 (see FIG. 3) is wrapped around rod 142, as a conventional window shade. The rotation of rod 142 allows window covering 143 to be rolled onto rod 142 so it does not obstruct the view out of window 108, or window covering 143 may be unrolled to partially or fully obstruct the view out of window 108, when the rod is positioned at the top of the window. The shade material may be either opaque or translucent, with the translucent variety allowing light but not images through.

While conventional roll shades are preferred, other window coverings 143 may be used either for decorative purposes or because they are effective at blocking or diffusing light. For example, window covering 143 may be conventional horizontal venetian blinds that can be raised or lowered, as well as tilted to adjust the amount of light to enter, or they may be vertically-pulled drapes, or with high tech, they may be flexible roll shades whose opacity can be electrically controlled, such as by using liquid crystal technology.

Each bracket 151, 152 is positioned between a different upper and lower line orienting member. For example, bracket 151 is positioned between line orienting members 111, 114 and bracket 152 is positioned between line orienting members 112, 113.

One end of bracket 151 attaches to line 120, keeping the associated end of rod 142 from moving up or down with respect to line 120. Bracket 151 extends outward from line 120, away from window frame 105 to provide a connection point for rod 142. This connection point keeps rod 142 from translating with respect to the brackets, but allows rod 142 to rotate between brackets 151 and 152, with one end engaging in a non-rotational relation and the other end engaging in a rotational relation, as is conventional with roll window shades.

Because rod 142 is coupled to line 120 at ends 144 and 146, a user may adjust the height of window covering apparatus 140 by moving line 120 on line orienting members 111-114. Pulling downward on line 120 between line orienting members 112, 113 causes window covering apparatus 140 to also move downward. Conversely, pulling up on line 120 between line orienting members 112, 113 causes window covering apparatus 140 to move upward. This feature allows a user to position window covering apparatus 140 at varying heights on window 108 without it tilting during the process.

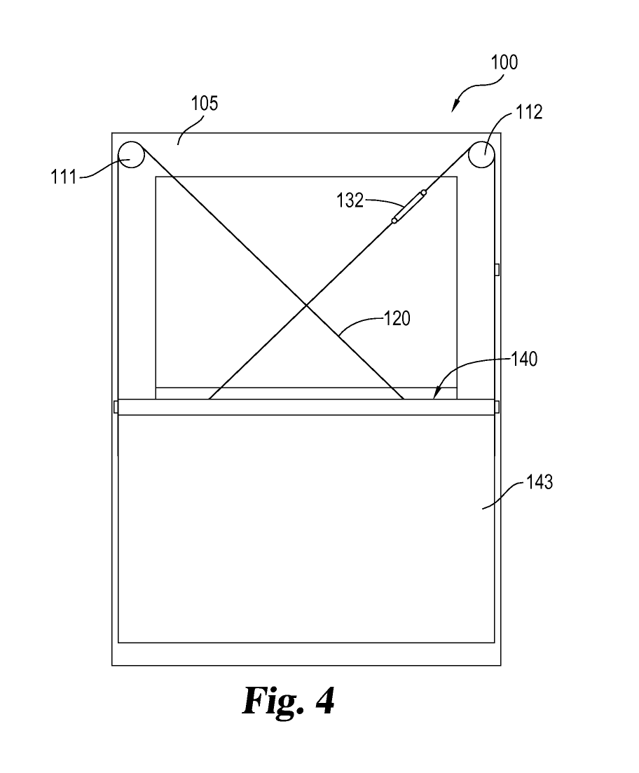

A user thus has the option of covering either the upper or lower portions of window 108 while leaving other portions unobstructed. For example, as seen in FIG. 3, a user may move window covering apparatus 140 to the top of window 108 and partially unroll window covering 143 to cover the top half of window 108. However, if the user wants to shade only the bottom half of window 108, as shown in FIG. 4, window covering apparatus 140 may be lowered so it is close to line orienting members 113, 114. Window covering 143 is then unrolled to cover the bottom half of window 108. In this setup, light coming in from the bottom of window 108 is obstructed, but light from the top of window 108 is allowed through.

As shown in FIGS. 3-4, the position of spring 132 changes as window covering apparatus 140 is moved between the line orienting members. For the embodiment shown, when apparatus 140 is positioned at the top of window 108 near line orienting members 111, 112, spring 132 is close to line orienting member 114. If apparatus 140 is moved lower on window frame 105, spring 132 moves so it is close to line orienting member 112. Because the diagonal will always be longer than the vertical height between line orienting members, if the spring length is less than this difference, proper positioning of the spring 132 with respect to the attachment of brackets 151 and 152 to line 120 avoids interfering with the operation when the spring nears line orienting members 112 or 114 as the apparatus 140 is positioned throughout its vertical range.

In other embodiments, line 120 may include a second spring (not shown) positioned between line orienting members 111, 113. The use of two springs allows for two shorter individual springs to achieve a similar tension effect as one large spring, and yet further lessens the possibility of the spring causing interference by hitting a line orienting member.

Movement of line 120 and, in turn, window covering apparatus 140 can be accomplished by pulling on line 120. Pulling downward on line 120 between line orienting members 112 and 113, or between line orienting members 111 and 114, causes window covering apparatus 140 to also move downward. A user may also pull on line 120 where it crosses window 108. If the user pulls down on the diagonal portion of line 120 between line orienting members 112, 114, or between line orienting members 111 and 113, the window covering apparatus 140 moves upward.

Other apparatuses may be attached to system 100 to allow for adjustment of the height of window covering apparatus 140. In FIG. 5, for example, line orienting members 111-112 may be pulleys, with an electric motor 160 attached to line orienting member 112 to rotate that pulley to adjust the height of the window covering apparatus 140. In some embodiments, electric motor 160 may be a worm drive motor. A worm drive motor is an example of a motor that tends not to rotate from force applied to its output, but which can readily rotate when energized to change the position of the window covering apparatus 140. A wired control 161 is shown with a plug 162 for electrical power, although wireless operation such as with ultrasound or RF, optionally using battery power, (not shown) would be a suitable alternative for control. Another adjustment mechanism may be a wand (not shown) attached to one of the line orienting members that rotates the line orienting member when the wand is rotated by a user.

The weight of the window covering apparatus 140 on line 120 applies a downward force on the window covering apparatus 140 that could lessen its stability. There are different ways to address this. For example, as seen in FIG. 5, a counterweight 156 can be attached to line 120 to add a counterbalancing weight. Preferably counterweight 156 is coaxial with line 120. A second or alternative placement of the first coaxial counterweight (not shown) could be the other diagonal portion of line 120 where it would not compromise the spring length. In another example, the choice of surface of one or more non-rotating line orienting members 111-114 may add sufficient friction that the weight of window covering apparatus does not overcome the static coefficient of friction to by itself move line 120.

In some embodiments not shown, tension pathway 115 may be arranged around line orienting members 111-114 so only one portion of line 120 crosses diagonally in front of window 108. For example, line 120 could start at a tension applying member 130 and extend from line orienting member 114 to line orienting member 111 and then across the top of window frame 105 to line orienting member 112. Line 120 is then extended downward to contact line orienting member 113 and then back up to line orienting member 112. Line 120 then crosses window 108 to connect with tension applying member 130. This arrangement allows counterweight 156 to be hung and move vertically from a line attached to line 120 between line orienting members 112, 113, so counterweight 156 does not impede the view from window 108.

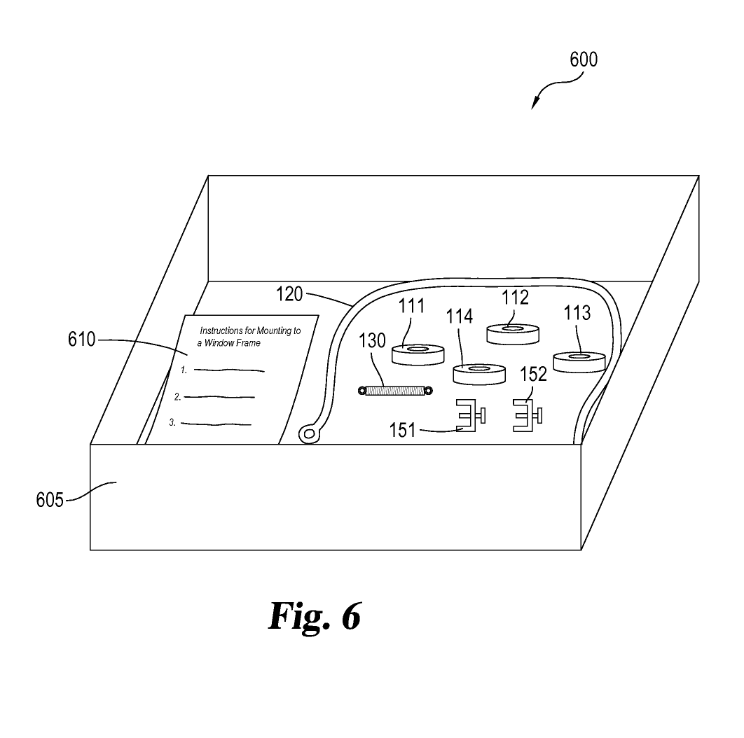

FIG. 6 illustrates an embodiment of a kit 600 containing items for mounting a window covering to a window frame. Kit 600 includes a container 605. Inside container 605 are four line orienting members 111-114 that are attachable to a window frame. Also included in kit 600 is a line 120, a tension applying member 130, and two brackets 151 and 152 for connecting a window covering apparatus to line 120. Instructions 610 that describe how to mount the components of the kit onto a window frame are also included in kit 600, preferably as a separate document, but alternatively as printing on the container itself directly or by a printed reference to an internet site that contains the detailed instructions. All of these options for instructions are to be construed as being contained within the container 605.

As shown in FIG. 6, the line orienting members 111-114 are preferably pulleys, but in other embodiments, line orienting members 111-114 may be any apparatus that supports line 120 with a suitable coefficient of friction. Tension applying member 130 is preferably a spring; however, it may alternatively be any apparatus that is able to apply tension to the line 120 when installed. Line 120 in kit 600 is preferably a stranded metal line, but it could be made of other materials, such as plastic, cotton, nylon, an aramid fiber, or any suitable alternative.

Other embodiments of kit 600 may include additional components than what is shown in FIG. 6. For example, kit 600 may include a rod that is attachable to line 120 and/or a window covering that is attachable to the rod so it may be rolled and unrolled.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected.

1. A system for mounting a window covering to a window frame comprising:
a window frame including two vertical sides;
four line orienting members coupled to the window frame wherein each vertical side includes an upper and a lower line orienting member;
two window covering engaging members, each one positioned between a different upper and lower line orienting member;
a line contacting each of said line orienting members and each of said window covering engaging members;
a tension applying member coupled to said line; and,
wherein when said line extends from one of said vertical sides to the other of said vertical sides, the line extends from said upper line orienting member on one vertical side to said lower line orienting member on the other vertical side.

2. The system of claim 1, comprising a rod extending across said window frame wherein the ends of said rod are attached to said window covering engaging members, and wherein movement of said line on said line orienting members adjusts the height of said rod.

3. The system of claim 1, wherein said tension applying member is selected from the group consisting of:
a tension spring connected between said the ends of said line; and,
a weight coupled to said line or to one of said line orienting members.

4. The system of claim 3, wherein said tension applying member comprises a spring loaded line orienting member.

5. The system of claim 4, wherein at least one of said line orienting members is rotatable.

6. The system of claim 5, comprising an electric motor coupled to said line.

7. The system of claim 6 in which said electric motor couples to said line through a rotatable line orienting member.

8. The system of claim 1, wherein said line is metal.

9. The system of claim 1, comprising a counterweight wherein said counterweight is coaxial with said line.

10. A system for mounting a window covering to a window frame comprising:
a window frame including two vertical sides;
a line orienting member attached to said window frame;
a tension pathway including a line wherein said line contacts said line orienting member;
wherein said tension pathway travels along both of said vertical sides of said window and wherein movement of said tension pathway on one vertical side causes said tension pathway to move in the same direction on the other vertical side; and,
wherein when said tension pathway extends between said vertical sides of the window frame, said tension pathway crosses an edge of said window frame at an angle between 20 degrees and 70 degrees.

11. The system of claim 10, comprising a rod wherein said rod has two sides and wherein said each of said sides is attached to said tension pathway.

12. The system of claim 11, wherein movement of said tension pathway on said line orienting members adjusts the height of said rod.

13. The system of claim 10, comprising a line-tension applying member.

14. The system of claim 13, wherein said line includes two line ends and wherein said line tension applying member is a tension spring connected between said two line ends.

15. The system of claim 13, wherein at least one of said line orienting members is rotatable.

16. The system of claim 15, comprising an electric motor coupled to said line.

17. The system of claim 16 in which said electric motor couples to said line through a rotatable line orienting member.

18. The system of claim 10, wherein said line is metal.

19. The system of claim 10, comprising a counterweight wherein said counterweight is coaxial with said line.

20. The system of claim 10, comprising an upper and a lower line orienting member attached to each vertical side of the window frame;
wherein said tension pathway extends between vertical sides of the window frame by extending from said upper line orienting member on one side to said lower line orienting member on the opposite side for each of said upper line orienting members.

21. The system of claim 20, wherein at least one of said line orienting members is rotatable.

22. The system of claim 20, comprising a line-tension applying member.

23. The system of claim 22, wherein said line includes two line ends and wherein said line-tension applying member is a tension spring connected between said two line ends.

24. A kit for mounting a window covering to a window frame comprising:
a container containing:
(a) four line orienting members that are attachable to a window frame;
(b) a line;
(c) a tension applying member;
(d) window covering engaging members for mounting between a window covering and said line; and,
(e) instructions for mounting to a window frame.

25. The kit of claim 24, further comprising a rod wherein said rod has two ends and each of said ends is attachable to said line by way of said brackets.

26. The kit of claim 25, further comprising a window covering attachable to said rod.

27. The kit of claim 24, wherein said line orienting members are pulleys.

28. The kit of claim 24, wherein said line is a metal line.

29. The kit of claim 24, wherein said tension applying member is a tension spring attachable to said line.

30. A system for mounting a window covering to a window frame comprising:
a window frame;
a line orienting member attached to said window frame;
a tension pathway including a line and a tension spring wherein said line contacts said line orienting member; and,
wherein said line has two ends and one of said ends is attached to said tension spring.

31. The line of claim 30, wherein said two ends of said line are attached to said tension spring.

32. A system for mounting a window covering to a window frame comprising:
a window frame;
a line orienting member attached to said window frame;
a tension pathway including a line and a counterweight wherein said counterweight is coupled to said line; and,
a variable height window covering extending across the window frame wherein locations on opposite sides of said window covering are attached to said line and wherein movement of said line on said line orienting member adjusts the height of said window covering in one direction while said counterweight moves in another direction.

33. The system of claim 32 in which said counterweight is coaxial with said line.
